(19) United States
(12) Patent Application Publication
(10) Pub. No.: US 2015/0178059 A1
(43) Pub. Date: Jun. 25, 2015

(54) APPLICATION LAUNCHING

(71) Applicant: Amazon Technologies, Inc., Reno, NV (US)

(72) Inventors: David Isaac Lindheimer, Mercer Island, WA (US); Gerard Joseph Heinz, II, Seattle, WA (US)

(21) Appl. No.: 14/137,761

(22) Filed: Dec. 20, 2013

(51) Int. Cl. G06F 9/445; H04L 29/08

(52) U.S. Cl. CPC G06F 8/61; H04L 67/10

(57) ABSTRACT

A user can request that an application be downloaded to a computing device. The computing device can establish an application streaming session with a server system. In the application streaming session, the server system can send application content to the computing device, the computing device can render the application content, the computing device can receive user inputs and the computing device can send input information back to the server system. The computing device can download and install the application during the application streaming session. In this way, the user can begin using the application via the application streaming session instead of waiting for the application to be downloaded and installed before using the application. When the user subsequently requests to use the application, the application installed on the computing device can be launched.

### BACKGROUND

Applications can be downloaded and installed on computing devices. Such applications can be made available for downloading and installing on mobile computing devices using a store application. A store application can, among other things, show applications that are available for download, indicate applications that are popular among other users of mobile computing devices and indicate recommendations for the user of the mobile computing device. Recommendations for a user can be personalized recommendations based on any of the user's previous downloads of applications, applications previously viewed by the user and many other factors. When an application is selected for download, the store application can register the application and any associated rights with the computing device.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 depicts an instance of a computing device that includes a store application.

FIGS. 2A, 2B, 2C and 2D depict a sequence of buying and downloading an application for purchase in a system that includes a computing device and a server system.

FIGS. 3A, 3B, 3C and 3D depict a sequence of requesting and downloading a free application in a system that includes a computing device and a server system.

FIG. 4 depicts an example of an application streaming session between a computing device and a server system.

FIGS. 5A, 5B, 5C and 5D depict a sequence of requesting and downloading a free application in a system that includes a computing device and a server system that treats the computing device as being entitled to free applications.

FIG. 6 depicts an example of a method that can be used on a computing device when a user first requests use of an application.

FIG. 7 depicts an example of a method can be used by a server system to respond to a request from for an application a computing device.

FIG. 8 depicts an embodiment of external components of a computing device.

FIG. 9 depicts an embodiment of internal components of a computing device.

FIG. 10 illustrates an example computing environment in which the embodiments described herein may be implemented.

FIG. 11 depicts a general-purpose computer system that includes or is configured to access one or more computer-accessible media.

### DETAILED DESCRIPTION

Applications can include computer instructions. Computer instructions can include one or more instructions that can be executed by a computing device. Computer instructions can include computer-readable instructions, computer-executable instructions, source code, compiled code, byte code, binary code, applet, assembly language and the like, or any combination thereof. Computer instructions can be written in an established programming language, such as Java, C, C++, Perl, JavaScript and the like. Mobile applications, in particular, can be written as native applications, platform-generic applications or hybrid applications. Native mobile applications are specific to a particular mobile platform, such as iOS or ANDROID. Such applications use development tools and language supported by the mobile platform, such as Xcode and Objective-C with iOS, Eclipse and Java with ANDROID and the like. Platform-generic applications can be written using languages that are generic to the mobile platform, such as HTML, HTML5, JavaScript, CSS and the like. Such applications can be distributed across a range of mobile platforms, though they may not be able to take full advantage of the specific capabilities of each mobile platform. Hybrid applications can include some platform-generic computer instructions, such as instructions written in HTML5, embedded inside of platform-specific computer instructions. Such hybrid applications are able to take advantage of specific functionality of the mobile platform, while the platform-generic portion can be used across mobile platforms.

Applications operating on a computing device can provide a user of the computing device with functionality. For example, email client applications can provide users with the ability to compose, send and receive email messages on the computing device; social network applications can allow users to interact within a social network from the computing device; gaming applications can allow a user to play a game on the computing device and/or participate in an online multiplayer game using the computing device; music and audio applications can allow a user to listen to and/or edit music and audio on the computing device; photo and video applications can allow a user to capture and/or edit pictures and video; and so forth. Each application provides a user of the mobile device with some functionality. Users can install any number of different applications on a computing device.

A user can take into account a number of factors when deciding whether to download an application. For example, a user can consider the price of the application, the particular features described for the application, any screenshots of the application that may be available and any other factor. One factor that may be a part of the user's decision is the amount of time that it may take to download the application file and install the application on the user's computing device before the user can actually use the application. While this delay may not factor into every decision whether to download an application, the delay may factor into the decision especially when the application is a free application. If an application is free, a user may be more likely to download an application if there is no delay or a minimal delay between the time that the user requests the application to be run and the time that the user will be able to use the application.

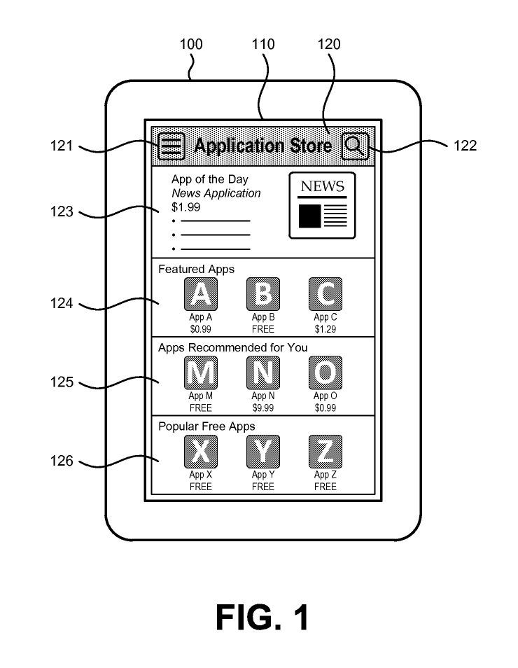

FIG. 1 depicts an instance of a computing device 100 that includes a store application 120. The computing device 100 includes a display 110 that can depict the store application 120. The store application 120 can include a menu button 121 that, when pressed, presents a number of options and/or features about the store application 120. The store application 120 can also have a search button 122 that, when pressed, allows a user to enter a search query to search for applications that are available for purchase and/or download using the store application 120. The store application 120 can also include sections with recommendations for the user, such as an application-of-the-day section 123, a featured applications section 124, a personalized recommendation section 125, popular applications section 126 that includes applications of a particular genre and any other sections that depict applications.

The computing device 100 can be any type of computing device. For example, the computing device 100 can be a portable computing device, such as a cell phone, a tablet computing device, a personal digital assistant (PDA), a laptop computer or any other portable computing device. In another example, the computing device 100 can be a non-mobile computing device, such as a desktop computer, a workstation, a gaming console, a television or any other type of non-mobile computing device.

As shown in FIG. 1, the store application 120 can show icons of the applications, names of the application and prices of the applications. Although not depicted in FIG. 1, the store application 120 can also include information about genres of the applications, developers of the applications, popularity of the applications and any other type of information. The store application 120 can be used as a way to advertise applications and encourage users to download applications. An operator of the store application may want to encourage users to download applications as much as possible and reduce or eliminate any barriers to users to increase the numbers of application downloads.

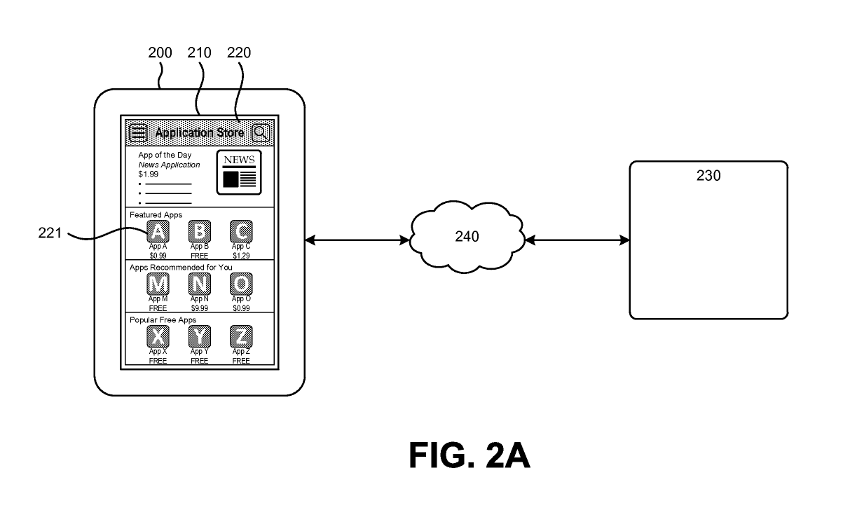

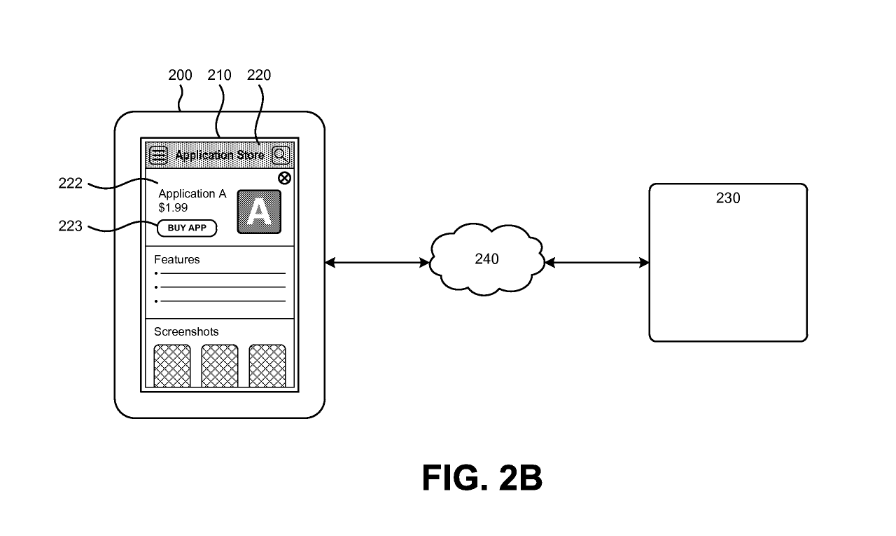

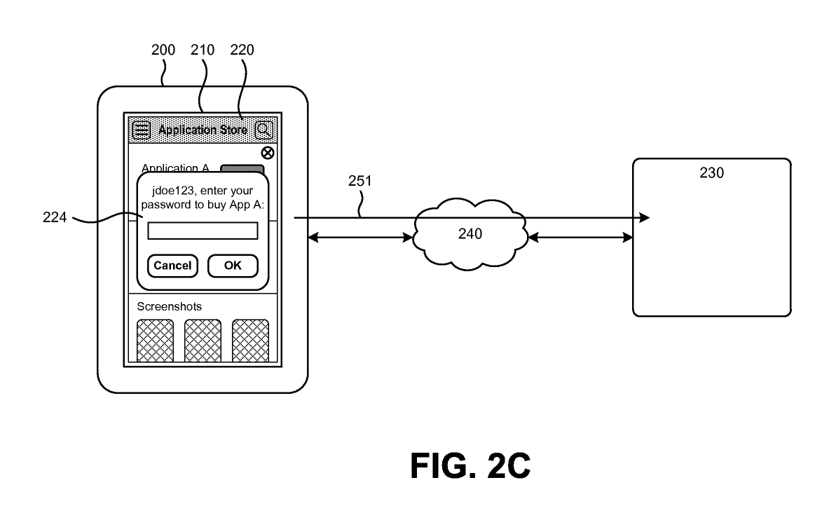

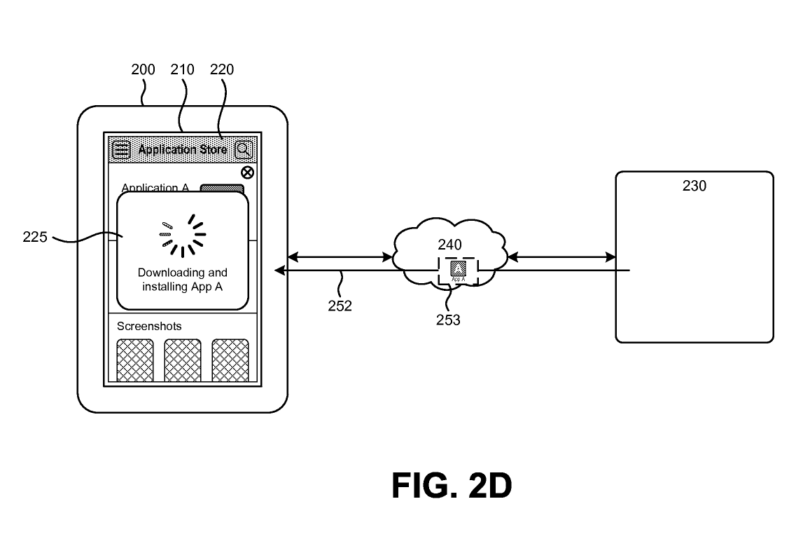

FIGS. 2A-2D depict a sequence of buying and downloading an application for purchase in a system that includes a computing device 200 and a server system 230. The system depicted in FIGS. 2A-2D includes a computing device 200 that is in communication with a network 240 and server system 230 that is in communication with the network 240. The network 240 can include any number of wired networks, wireless networks or any combination of wired and/or wireless networks. For example, the network 240 can include the Internet where the computing device 200 is connected to the network 240 via a cellular data network, and the server system 230 is connected to the network 240 by an electrical or optical connection. The server system 230 can include a single computing device or a number of computing devices. For example, the server system 230 can be a single server computing device, a data center that includes a number of computing devices, a server rack that includes a number of individual server computing devices and any other type of configuration.

As shown in FIG. 2A, the computing device 200 can include a display 210 that can display a store application 220. The store application 220 can show information about applications that are available for download to the computing device 200. The store application 220 can obtain the information about the applications from the server system 230. A user of the computing device 200 can select any of the applications to obtain more information about the application. For example, the user can select an icon 221 associated with Application A, shown in FIG. 2A, and the store application 220 can display more information about Application A.

FIG. 2B depicts an information page 222 about Application A. The information page can include information, such as a description of features of Application A, screenshots from Application A, optimal computing resources to run Application A or any other type of information. In the particular instance depicted in FIG. 2B, Application A is a paid application that the user can purchase and download to the computing device. The information page 222 can include a purchase button 223. When the user presses the purchase button, the store application 220 can initiate a process for the user to purchase Application A.

FIG. 2C depicts a portion of an application purchase process, including a verification page 224. In the particular verification page 224 shown in FIG. 2C, the user is prompted to enter a password. A username (jdoe123) is also displayed in the verification page 224 to indicate the account that is being used to purchase the application. While the particular verification page 224 shown in FIG. 2C is prompting for a password, many other forms of verification can be used in place of or in addition to a password. For example, biometric verification (e.g., reading a fingerprint of the user, taking an image of the user, etc.) can be used to verify the user in place of or in addition to a password. In another example, a security question could be asked of the user in place of or in addition to a password. The answer to the security question could have been provided previously, and the answer to the security question may be something that only the user or a few people would know. Any other form of verification could be used in place of or in addition to the password verification depicted in FIG. 2C.

Once the user has responded to the verification page 224 (e.g., provided a password), the user's response to the verification page 224 can be verified. In one embodiment, the computing device 200 may be able to verify whether the user provided a proper response to the verification page 224. The computing device 200 may send a communication 251 to the server system 230 via network 240 indicating that the user has been verified and requesting that the appropriate application file be downloaded to the computing device 200. In another embodiment, whether the computing device 200 receives the user's response to the verification page 224 (e.g., the user enters a password), the user's response can be sent in the communication 251 to the server system 230 for verification by the server system 230. In this case, the computing device 200 may encrypt the user's response or otherwise obscure the user's response before sending the communication 251 to the server system 230 so that the user's response will not be compromised during transmission to the server system 230 via the network 240. In this latter case, the server system 230 may be able to verify whether the user provided a proper response to the verification page 224. The communication 251 that includes the user's response can also include an indication of the application or application file to be downloaded to the computing device 200 upon verification of the user's response. Once the user verification process is complete (whether by the computing device 200 or the server system 230), the server system 230 can complete the payment by charging an account of the user for the amount of the purchase prices. At that point, the computing device 200 can be entitled to the purchased application.

FIG. 2D depicts the computing device 200 and the server system 230 at a time after the computing device 200 is entitled to the purchased application. The server system 230 can send a communication 252 to the computing device. The communication 252 can include an application file 253. The application file 253 can include application code for a compiled application and other information used by the application. For example, the application file can include all of the application's code, resources used by the application, assets of the application, any certificates for the application and a manifest file. Examples of application files include “.apk” files for ANDROID applications and “.msi” files for WINDOWS application. In the depiction shown in FIG. 2D, the application file 253 can include the application code and other information used by the application so that the computing device 200 can install and run the application.

In addition to the application file 253, the communication 252 can also include other information. For example, the communication 252 can include digital rights management (DRM) information that will provide the computing device 200 with rights to launch and use the application. In general, rights to launch and use applications can be managed by DRM systems. A DRM system can control the types of rights that a computing device has to an application. Examples of types of rights to an application include full rights to execute an application at any time for any use, limited rights to execute portions of an application or to execute an application for limited time periods and the like. DRM systems can be implemented in hardware and/or software. For example, a store application operating on a computing device can have DRM functionality to control execution of applications obtained using the store application. DRM functionality can be implemented on a client-side basis where DRM functionality is located on a computing device to control execution of applications on that computing device. DRM functionality can also be implemented on server-side basis where DRM functionality is located on a server or other computing device to control execution of applications on one or more client devices.

Once the computing device 200 receives the communication 252, it can install the application using the application file 253. Once the application is installed on the computing device 200, the user can run the application. However, there can be a delay between the time that the user enters a response into the verification page 224 and the time that the application is installed and ready for use. This delay can be caused by a number of reasons, such as the time it may take to verify the user's response to the verification page 224, the time it takes to send communication 251 from the computing device 200 to the server system 230, the time it takes to send communication 252 from the server system 230 to the computing device 200, the size of the application file 253, the limitations of communications across network 240 (e.g., limits on the speed of communication via the network, the types of connections that the computing device 200 and the server system 230 have with the network 240, etc.), limitations of the computing resources in the computing device 200 when installing the application and any other reason that could cause delay. Such a delay could take second, minutes or longer depending on the various factors that could cause delay.

During the delay between the time that the user enters a response into the verification page 224 and the time that the application is installed and ready for use, the computing device 200 can display a notification 225 that the downloading and installing processes are being completed. While the notification 225 may help a user understand what is happening during the delay, the length of the delay may not be known, and the user may have to simply have to wait until the notification 225 is no longer displayed.

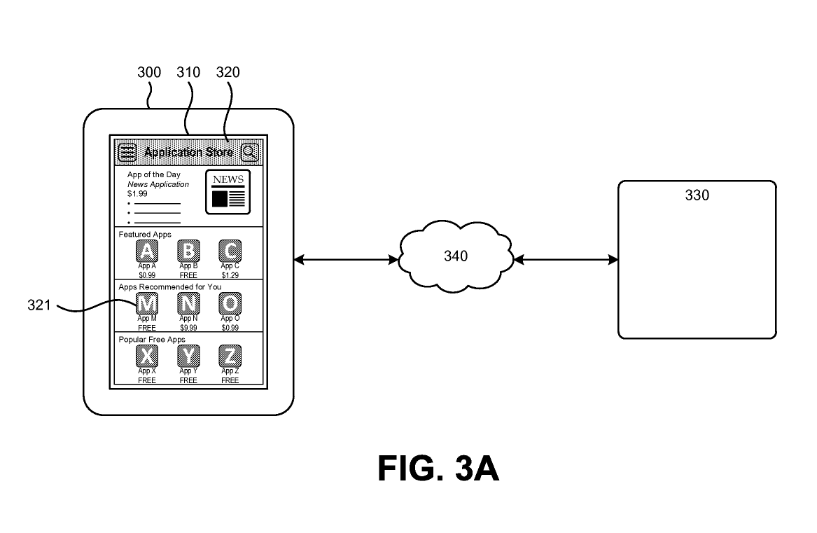

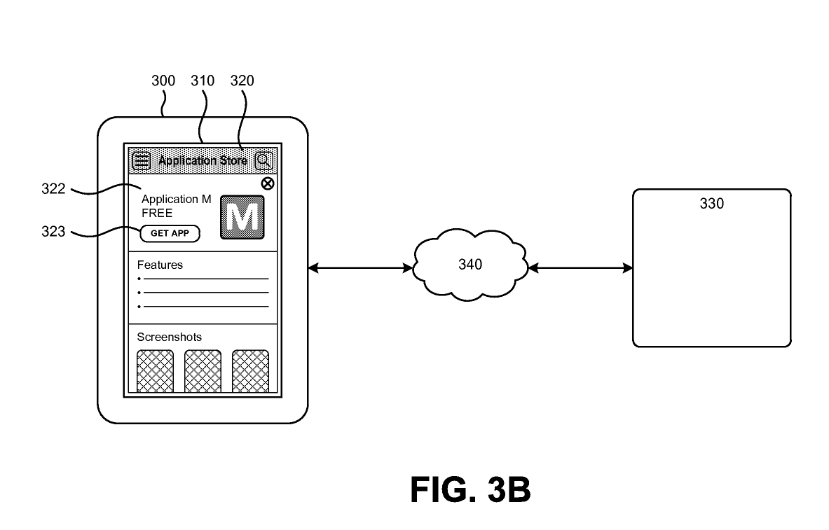

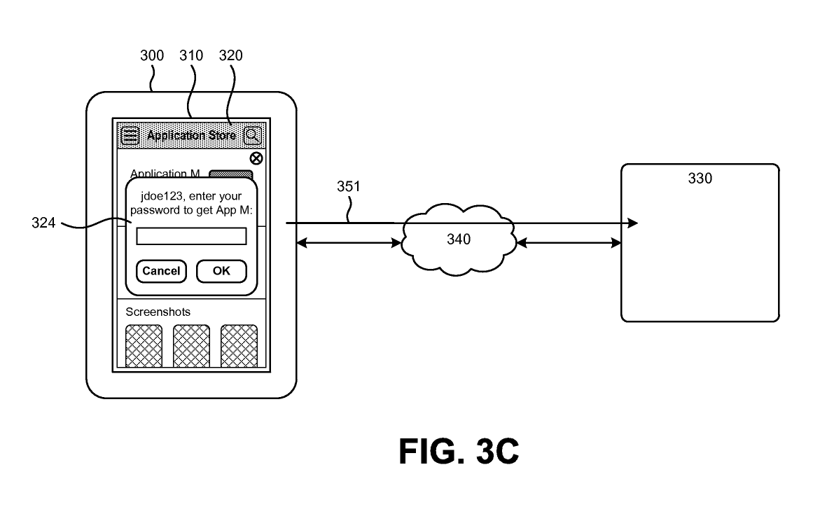

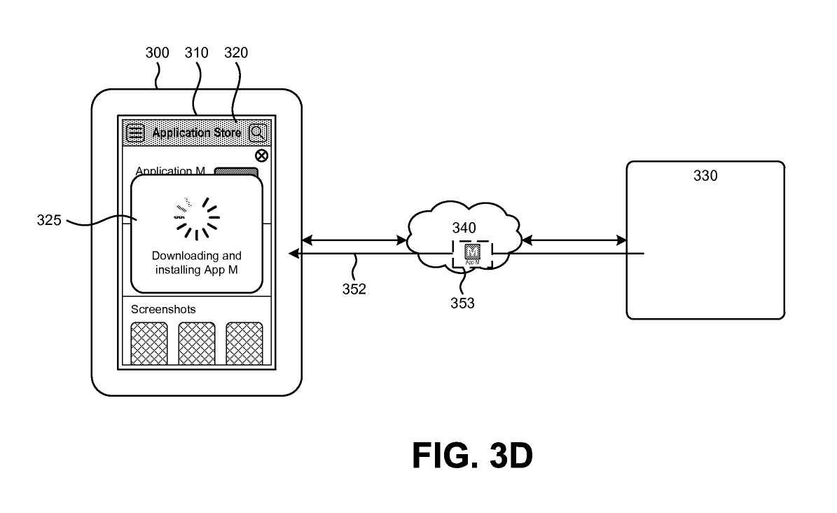

FIGS. 3A-3D depict a sequence of requesting and downloading a free application in a system that includes a computing device 300 and a server system 330. The system depicted in FIGS. 3A-3D includes a computing device 300 that is in communication with a network 340 and server system 330 that is in communication with the network 340. As shown in FIG. 3A, the computing device 300 can include a display 310 that can display a store application 320. The store application 320 can show information about applications that are available for download to the computing device 300. A user of the computing device 300 can select any of the applications to obtain more information about the application. For example, the user can select an icon 321 associated with Application M, shown in FIG. 3A, and the store application 320 can display more information about Application M.

FIG. 3B depicts an information page 322 about Application M. The information page can include information, such as a description of features of Application M, screenshots from Application M, optimal computing resources to run Application M or any other type of information. In the particular instance depicted in FIG. 3B, Application M is a free application that the user can download Application M to the computing device without making a payment. The information page 322 can include a download button 323. When the user presses the download button 323, the store application 320 can initiate a process for the user to download Application M.

FIG. 3C depicts a verification process to allow the computing device 300 to be entitled to the application. Store application 320 can depicts a verification page 324. In the particular verification page 324 shown in FIG. 3C, the user is prompted to enter a password associated with a particular username. While the particular verification page 324 shown in FIG. 3C is prompting for a password, many other forms of verification can be used in place of or in addition to a password, such as biometric verification, security questions and others. Once the user has responded to the verification page 324 (e.g., provided a password), the user's response to the verification page 324 can be verified. The user's response can be verified either by the computing device 300 or by the server system 330. The computing device 300 can send a communication 351 to the server system 330 via network 340 that includes a request for the appropriate application file to be downloaded to the computing device 300. The communication 351 can also include the user's response or an encrypted/obscured version of the user's response if the server system 330 will verify the user's response to the verification page 324. Once the user verification process is complete (whether by the computing device 300 or the server system 330), the computing device 300 can be entitled to the requested application.

FIG. 3D depicts the computing device 300 and the server system 330 at a time after the computing device 300 is entitled to the requested application. The server system 330 can send a communication 352 to the computing device that includes an application file 353. The application file 353 can include application code for a compiled application and other information used by the application. In addition to the application file 353, the communication 352 can also include other information, such as DRM information that will provide the computing device 300 with rights to launch and use the application.

Once the computing device 300 receives the communication 352, it can install the application using the application file 353. Once the application is installed on the computing device 300, the user can run the application. However, just as with the purchased application describe above with respect to FIGS. 2A-2D, there can be a delay between the time that the user enters a response into the verification page 324 and the time that the application is installed and ready for use. This delay can be caused by a number of reasons, such as the time it may take to verify the user's response to the verification page 324, the time it takes to send communication 351 from the computing device 300 to the server system 330, the time it takes to send communication 352 from the server system 330 to the computing device 300, the size of the application file 353, the limitations of communications across network 340, the limitations of the computing resources in the computing device 300 when installing the application and any other reason that could cause delay. Such a delay could take second, minutes or longer depending on the various factors that could cause delay.

During the delay between the time that the user enters a response into the verification page 324 and the time that the application is installed and ready for use, the computing device 300 can display a notification 325 that the downloading and installing processes are being completed. While the notification 325 may help a user understand what is happening during the delay, the length of the delay may not be known, and the user may have to simply have to wait until the notification 325 is no longer displayed.

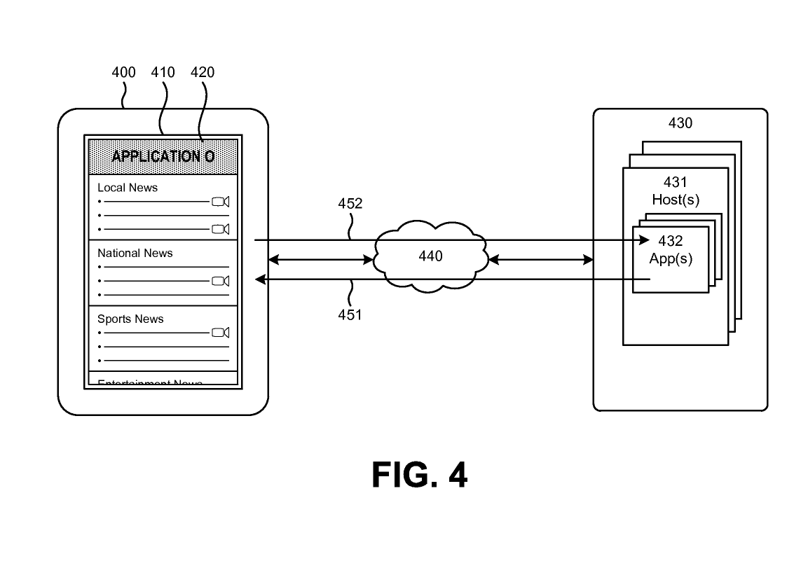

FIG. 4 depicts an example of an application streaming session between a computing device 400 and a server system 430. The system depicted in FIG. 4 includes a computing device 400 that is in communication with a network 440 and server system 430 that is in communication with the network 440. The computing device 400 includes a display 410 that can render visual application content 420. The server system 430 can include one or more hosts 431. The hosts 431 can be individual computing devices, such as individual server computing devices within a data center. The hosts 431 can also be virtualized instances operating on one or more computing devices. The hosts 431 can run one or more applications 432. The one or more applications 432 can be applications that are available for download to computing device 400.

In the application streaming session, the server system 430 can send communications 451 to the computing device 400. The communications 451 can include application content generated by the one or more applications 432. The application content can include video content and/or audio content. The video content can include content that, when rendered as visual application content 420 on the display 410, appears with little to no difference than if the application is actually running on the computing device 400. The audio content can include content that can be rendered by an audio device, such as a speaker or headphones. The communications 451 that include the application content can be sent in a stream from the server system 430 to the computing device 400 such that the streamed application content is regularly updated and the visual application content 420 on the display 410 changes with differences in the streamed application content. In this way, changes in the application content generated by the one or more applications 432 can result in changes to the visual application content 420 on the display 410.

In the application streaming session, the computing device 400 can send communications 452 to the server system 430. The communications 452 can include input and control information. The input and control information can indicate user inputs, such as when a user presses a touch screen or clicks a mouse at a particular location on the display 410. The input and control information can also indicate control information that can be used to update how the one or more applications 432 are running and/or how the application content is sent in communications 451. The communications 452 that include the input and control information can be sent in a stream from the computing device 400 to the server system 430 such that the input and control information is regularly received by the server system 430, and the server system 430 can update to the one or more applications 432 accordingly.

One benefit of the application streaming session depicted in FIG. 4 is that the one or more applications 432 can be installed and running on the hosts 431 before the application streaming session is initiated by the computing device 400. In that case, when the computing device 400 first sends a request to the server system 430 to initiate an application streaming session, the visual application content 420 can be rendered on the display 410 as soon as the computing device 400 starts receiving the communications 451. The time it takes for the computing device 400 to send the server system 430 a request to initiate the application streaming session and to begin receiving the communications 451 can be much shorter than the time it takes for the computing device 400 to send a request to the server system 430 to download an application, download the application from the server system 430, install the application on the computing device 400 and launch the computing device 400.

Another benefit of the application streaming session depicted in FIG. 4 is that a user of the computing device can interact with the visual application content 420 rendered on the display 410 in the same way that the user would interact with an application installed and running on the computing device 400. For example, in the example of Application O depicted in FIG. 4, the user can select one of the lines (representing a link to a news story) underneath “Local News,” the user selection can be sent via communications 452 to the server system 430, the one or more applications 432 can retrieve the link and generate application content showing the linked news story and send generated application content via communications 451 to the computing device 400. In this example, the user's experience of selecting a link to a news story and seeing the linked news story may not be any different than if the application was running on the computing device 400.

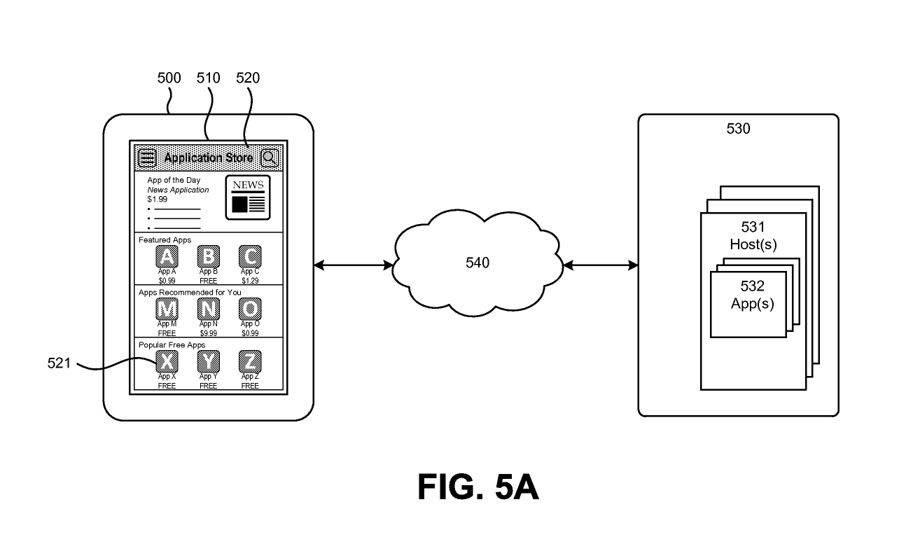

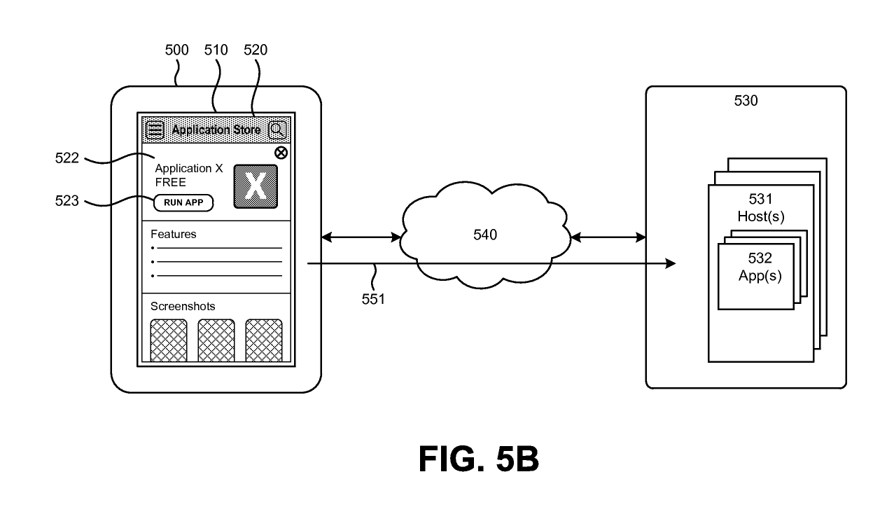

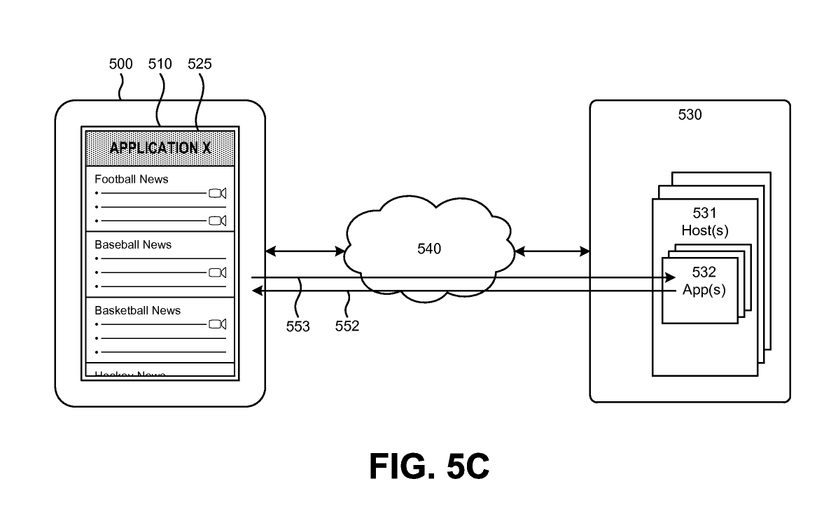

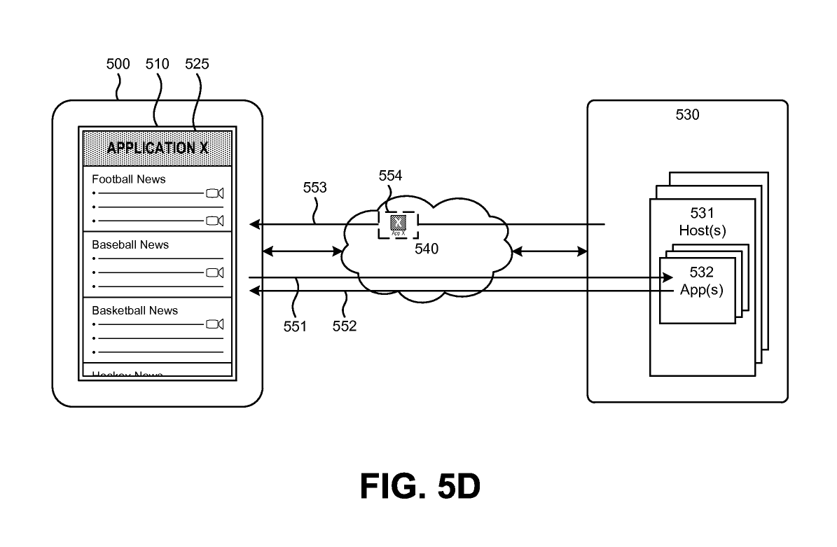

Taking these benefits together, the application streaming session depicted in FIG. 4 can be used to reduce the delay between a user requesting a new application and the user being able to use the application. When a user requests use of a free application, the computing device 400 can send a request to the server system 430 and application streaming session for that free application can be initiated between the server system 430 and the computing device 400. In the case of free applications, the delay between the user requesting a free application and the user being able to use the free application in an application streaming session can be further reduced by the server system 430 treating the computing device 400 as being entitled to all free applications without requiring verification. An example of treating a computing device as being entitled to all free applications without requiring verification is shown in FIGS. 5A-5D.

FIGS. 5A-5D depict a sequence of requesting and downloading a free application in a system that includes a computing device 500 and a server system 530 that treats the computing device 500 as being entitled to free applications. The system depicted in FIGS. 5A-5D includes a computing device 500 that is in communication with a network 540 and server system 530 that is in communication with the network 540. As shown in FIG. 5A, the computing device 500 can include a display 510 that can display a store application 520. The store application 520 can show information about applications that are available for download to the computing device 500. A user of the computing device 500 can select any of the applications to obtain more information about the application. For example, the user can select an icon 521 associated with Application X, shown in FIG. 5A, and the store application 520 can display more information about Application X.

FIG. 5B depicts an information page 522 about Application X. The information page can include information, such as a description of features of Application X, screenshots from Application X, optimal computing resources to run Application X or any other type of information. In the particular instance depicted in FIG. 5B, Application X is a free application that the user can download Application X to the computing device without making a payment. The information page 522 can include a run application button 523. When the user presses the run application button 523, the store application 520 can send a communication 551 requesting use of Application X by computing device 500. If the server system 530 treats the computing device 500 as being entitled to free applications, the user may not need to enter a password or otherwise provide any verification before the computing device 500 sends communication 551 about a free application to the server system 530. When the server system 530 receives the communication 551, it can initiate an application streaming session with an application 532 running in host 531.

FIG. 5C depicts an application streaming session between the server system 530 and the computing device 500. The server system 530 can send communications 552 to the computing device 500. The communications 552 can include application content generated by the application 532. The application 532 can be a version of Application X that can run on the host 531 and generate the application content. The application content can include video content and/or audio content associated with Application X. The video content can include content that, when rendered as visual application content 525 on the display 510, appears with little to no difference than if Application X was actually running on the computing device 500. The audio content can include content that can be rendered by an audio device, such as a speaker or headphones. The computing device 500 can send communications 553 to the server system 530. The communications 553 can include input and control information. The input and control information can indicate user inputs and/or control information for providing inputs to and/or controlling application 532. The input and control information in communications 553 can effectively allow the user to control application 532 by providing inputs to the computing device 500.

In one embodiment, the application 532 running on the host 531 can be a multi-tenant application that can be used with multiple concurrent application streaming sessions. The multi-tenant application allows for multiple computing devices to be engaged in application streaming sessions. This allows an operator of the server system to scale up the number of computing devices that can be served by application streaming sessions. Moreover, if the number of application streaming sessions in server system 530 is approaching a limit of the number of possible application streaming sessions that can be handled at one time, the server system 530 can add additional hosts, such as by launching new virtualized instances to server system 530 as hosts, provisioning additional server computing devices in the server system 530 and the like.

The application streaming session for Application X can provide the user with the appearance that Application X is actually operating on the computing device 500. By initiating an application streaming session for Application X in response to the user pressing the run application button 523, the time that takes for the visual application content 525 of Application X to appear on the display 510 can be much shorter than the time that would be required to download Application X to the computing device 500 and install Application X on the computing device 500. Thus, it may feel to the user as if pressing the run application button 523 enables the user to launch Application X. In this way, it can feel to the user as if the free applications shown in the store application 520 are essentially part of a library of applications that have been installed on computing device 500.

FIG. 5D depicts the computing device 500 and the server system 530 at a time during at least a portion of the application streaming session. The server system 530 can send a communication 553 to the computing device 500 that includes an application file 554. The application file 554 can include application code for Application X and other information used by Application X. In addition to the application file 554, the communication 553 can also include other information, such as DRM information that will provide the computing device 500 with rights to launch and use the Application X. The communication 553 can be sent to the computing device 500, and the computing device 500 can install Application X using the application file 554, while the user interacts with the visual application content 525 on the display 510. This allows the user to try out Application X during the time that it takes the application file 554 to be downloaded and the time that it takes Application X to be installed.

When the user stops using Application X via the application streaming session, the application streaming session can be halted. The server system 530 can stop sending communications 552 to the computing device 500 and the computing device 500 can stop sending communications 553 to the server system 530. The next time that the user attempts to use Application X, the computing device 500 can launch Application X that has been installed on the computing device 500 instead of initiating an application streaming session. In this example, the user may not be able to tell the difference between the first time that the user was interacting with Application X (via the application streaming session) and the second time that the user was interacting with Application X (via the application running locally on computing device 500).

When a user first interacts with an application via an application streaming session and later interacts with the application via the application running locally on a computing device, any state information developed during application streaming session may be passed from a server system to the computing device after the application streaming session is halted. State information can include any information about the use of the application, such as a number of levels passed in a game application, account sign on credentials (e.g., username and password) for an account associated with the application and the like. The server system can send state information developed during the application streaming session to the computing device in response to the application streaming session being halted. The computing device can use the state information to modify the application when the application is launched locally on the computing device.

One issue with reducing barriers to users downloading free applications is that users may download large numbers of free applications to their computing devices. Downloading a large number of applications to a computing device may have adverse effects, such as taking up large amounts of memory on a computing device. In one embodiment, a limit may be set for the amount of memory that can be used to store free applications. In this case, the computing device may continue to download free applications until the amount of memory for free applications is filled. At that point, the computing device may signal to a user that more free applications cannot be downloaded until some free applications are deleted. In another embodiment, when a user requests to download a new free application and an amount of memory for free applications is filled, the computing device may delete the oldest free application on the computing device to make room for a new free application to be downloaded, in a first-in-first-out (FIFO) manner. In another embodiment, the user may be able to designate any of the free applications as applications that should not be deleted until the user specifically requests that the application be deleted. In this embodiment, an application that the user wants to keep will not be inadvertently deleted using a scheme, such as a FIFO scheme. Any number of other memory management schemes could be used.

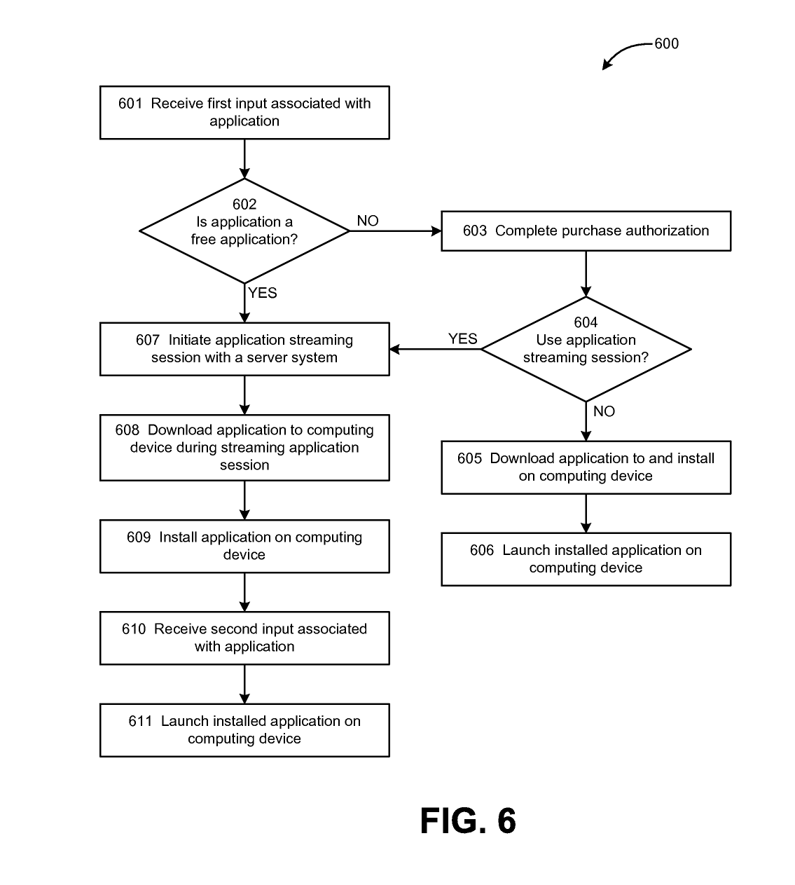

FIG. 6 depicts an example of a method 600 that can be used on a computing device when a user first requests use of an application. At block 601, the computing device can receive a first input associated with an application. The first input can be a request to run the application on the computing device, a request to install the application on the computing device, a request to purchase the application, and the like. Such a first input can be made by a user pressing a button, such as the purchase button 223 depicted in FIG. 2B, the download button 323 depicted in FIG. 3B or the run application button 523 depicted in FIG. 5B. A user can make such a first input in any number of other ways. At block 602, a decision can be made whether the application is a free application or a paid application.

If, at block 602, the computing device determines that the application is a paid application, then, at block 603, the computing device can allow the user to complete a purchase authorization for the application. The computing device can present a verification page, such as the verification page 224 depicted in FIG. 2C. The verification page can prompt a user to enter a password, enter biometric information, answer a security question or enter any other form of verification information to authorize purchase of the application. At block 604, a determination can be made whether to use a streaming application session. If, at block 604, a determination is made not to use a streaming application session then, at block 605, the application can be downloaded to the computing device and installed on the computing device. Downloading the application can include downloading an application file for the application. At block 606, the computing device can launch the installed application. The user can interact with the launched application.

If, at block 602, the computing device determines that the application is a free application or if, at block 604, a determination is made to use a streaming application session, then, at block 607, the computing device initiate an application streaming session with a server system. The application streaming session can include the application running on a host in the server system. The server system can send application content generated by the application to the computing device. The computing device can render the application content. The computing device can receive user inputs while rendering the application content and send indications of the user inputs to the application running on the server system. At block 608, the application can be downloaded to the computing device during the application streaming session. Downloading the application to the computing device can include downloading an application file to the computing device. Downloading the application to the computing device during the application streaming session can mean that at least a portion of the application is downloaded to the computing device during at least a portion of the application streaming session. In other words, the downloading of the application to the computing device can occur in parallel with the operation of the application streaming session. At block 609, the downloaded application can be installed on the computing device.

At block 610, the computing device can receive a second input associated with the application. The second input can be made during the application streaming session or after the application streaming session has been halted. The second request can be made by the user pressing a button in a store application, by pressing an icon for the application within an operating system on the computing device, or in any other way. At block 611, the computing device can lunch the application that has been installed on the computing device. At this point the user can interact with the application installed locally on the computing device. The change from the application streaming session to the local copy of the application can occur between different uses of the application (e.g., after the user closes the application streaming session, the next time the user uses the application the computing device can launch the locally-installed application). The change from the application streaming session to the local copy of the application can occur at a natural break in the operation of the application (e.g., when a user finishes a level of the application using the application streaming session, when the user inputs a selection to start a new level the application installed locally on the computing device can be launched and run the new level). There are many other examples of points which the change from the application streaming session to the local copy of the application can be made.

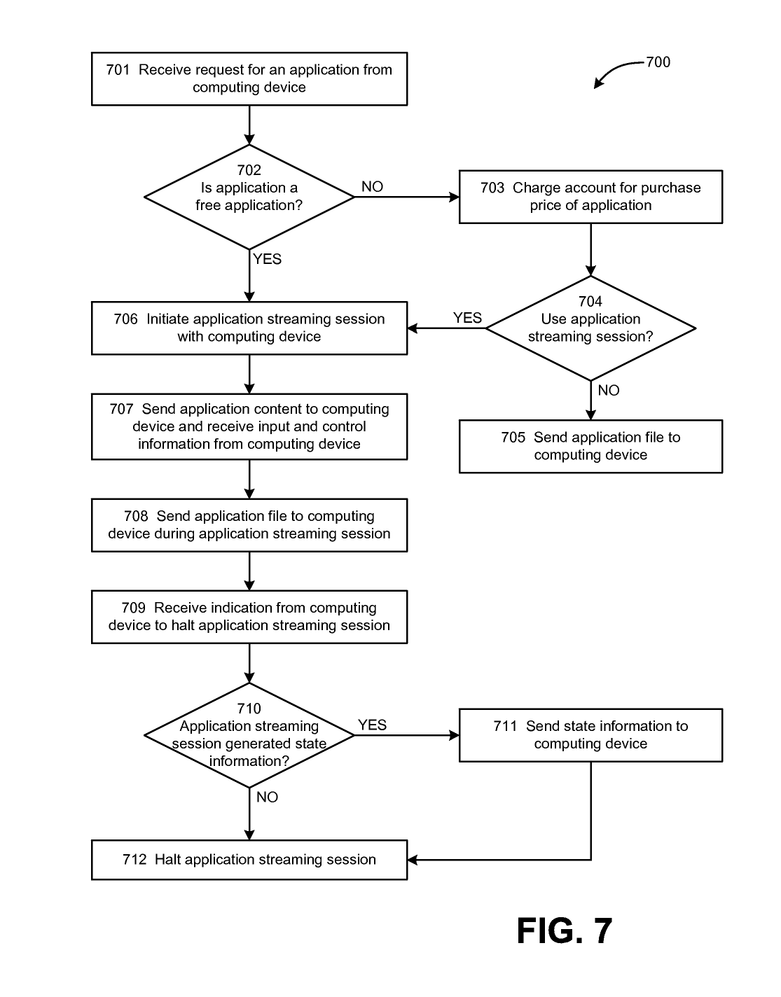

FIG. 7 depicts an example of a method 700 that can be used by a server system to respond to a request from for an application a computing device. At block 701, the server system can receive the request for the application from the computing device. The request can be sent from the computing device to the server system via one or more networks. At block 702, the server system can determine whether the application is a free application. If, at block 702, it is determined that the application is not a free application, then, at block 703, the server system can charge an account for the purchase price of the application. Charging the account can include completing a verification process. In one example, the verification process can include receiving an indication from the computing device that the computing device has received verification information (e.g., a password, biometric information, etc.) associated with the account. In another example, the verification process can include receiving verification information from the computing device and verifying that the verification information is associated with the account. In this latter example, the verification information can be encrypted and/or obscured when communicated from the computing device to the server system.

At block 704, a the server system can determine whether to use an application streaming session. If, at block 704, the server system determines not to use an application streaming session, then at block 705, the server system can send an application file for the application to the computing device. However, if at block 704, the server system determines to use an application streaming session, then the method can proceed to block 706. Also, if, at block 702, it is determined that the application is a free application, then, the method can proceed to block 706.

At block 706, the server system can initiate an application streaming session with the computing device. The application streaming session can be initiated by establishing a connection between an application running on a host in the server system to the computing device. At block 707, the server system can send application content to the computing device and the server system can receive input and control information from the computing device. The application content can be generated by the application running on the host in the server system. The application content can include video and/or audio content that can be rendered by the computing device. The input and control information can include indications of user inputs and/or settings for controlling the application running on the host in the server system. At block 708, the server system can send an application file for the application to the computing device during the application streaming session. Sending the application file to the computing device during the application streaming session can mean that at least a portion of the application file is downloaded to the computing device during at least a portion of the application streaming session.

At block 709, the server system can receive an indication from the computing device to halt the application streaming session. Such an indication can be sent by the computing device when a user attempts to close the application on the computing device, when the application has been installed on the computing device, or at any other time. At block 710, the server system can determine whether any state information was generated during the application streaming session. If, at block 710, the server system determines that state information was generated during the application streaming session, then, at block 711, the server system can send the state information to the computing device. The state information sent to the computing device can be used with the application installed on the computing device so that when the user runs the application installed on the computing device, the application running on the computing device can have the same state as the application from the application streaming session. The method can then proceed to block 712. However, if, at block 710, the server system determines that state information was not generated during the application streaming session, then the method can proceed to block 712. At block 712, the server system can halt the application streaming session. Halting the application streaming session can include halting a stream of the application content to the computing device.

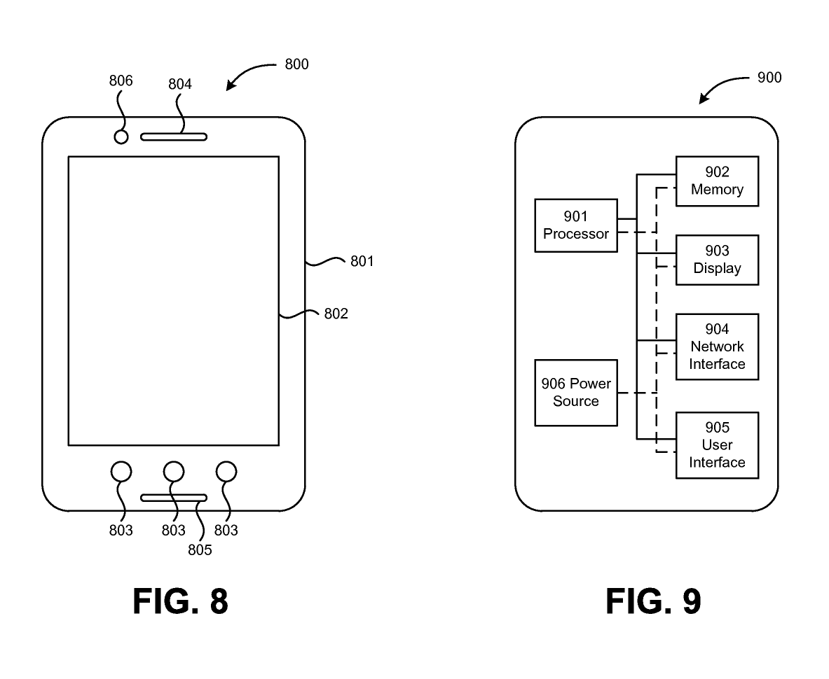

FIG. 8 depicts an embodiment of external components of a computing device 800. It should be understood that this is merely an example for discussion and that a number of additional components, configurations, assemblies and combinations are possible as known in the art. Computing device 800 can be any form of a computer, such as a desktop computer or laptop computer, a tablet computing device, a cell phone, a handheld computing device or any other form of computing device. Computing device 800 can include a housing 801. The housing 801 can be made of any material or combinations of materials, such as various types of plastic, metal, glass and combinations thereof, that is suitable to house the components of computing device 800. Computing device 800 can also include a display 802 that can display images, text, any other type of visual information and any combination thereof. Display 802 can also be a touchscreen display that is capable of sensing the presence and location of one or more touches of the display 802. A touchscreen display can sense touches by a user, such as a touch by a finger or a hand, and touches by objects, such as by a stylus. Display 802 can be part of a user interaction system of the computing device 800.

Computing device 800 can also include one or more hard buttons 803 integrated into housing 801. In one embodiment, the one or more hard buttons 803 can include a single button, such as a home button or a power button. In another embodiment, the one or more hard buttons 803 can include a small set of buttons, such as a power button, a home button and a back button. In yet another embodiment, the one or more hard buttons 803 can include a large set of buttons, such as a full QWERTY keyboard, a keypad and the like. The one or more hard buttons 803 can be part of the user interaction system of the computing device 800.

Computing device 800 can also include a speaker 804 configured to emit sounds and a microphone 805 configured to receive sounds. In the embodiment where computing device 800 is a cell phone, speaker 804 and microphone 805 can be used to carry on a telephone call. In one embodiment, speaker 804 can be configured to play sounds associated with graphics displayed on display 802, such as during play of audiovisual material on computing device 800. In another embodiment, microphone 805 can receive audio sounds, which the computing device 800 can interpret as user inputs. In addition, while not depicted in FIG. 8, computing device 800 can also include an audio port, which can be connected to an external microphone and/or an external speaker or speakers. Computing device 800 can send and receive audio signals via the audio port and interpret the received audio signals via the audio port just as it would interpret audio signals generated from sounds received by the microphone 805.

Computing device 800 can also include one or more optical devices 806. In one embodiment, an optical device can include an optical sensor, such as an infrared sensor, a visible light sensor and/or any device that can sense light and/or electromagnetic energy. The detection of light and/or electromagnetic energy can be used by the computing device 800 to control components of the computing device 800, such as a level of light emitted by a backlight of display 802, illumination of one or more hard buttons 803 and any other aspect of computing device 800. In another embodiment, an optical device can include an image-capturing device, such as a digital camera. An image-capturing device can include any device configured to capture an image, such as a complementary metal-oxide-semiconductor (CMOS) active pixel sensor (APS) and a charged coupled device (CCD). Images captured by one or more optical devices 806 can be stored by the computing device 800 as individual images or as a series of images in a video. Individual images and/or video images can be processed by computing device 800 and interpreted as user inputs. While FIG. 8 depicts one of the optical devices 806 pointing in the same direction as the display 802, it is possible for computing device 800 to have any number of optical devices 806, and it is possible for one or more optical devices 806 to be pointed in other directions, such as a rear-facing camera pointing in the opposite direction of display 802.

FIG. 9 depicts an embodiment of internal components of a computing device 900. It should be understood that this is merely an example for discussion and that a number of additional components, configurations, assemblies and combinations are possible as known in the art. Computing device 900 can include at least one processor 901 that is able to execute instructions stored in one or more memories 902. The one or more memories 902 can include instructions for running an operating system, instructions for running one or more applications within the operating system, a system management agent and any other kind of instructions. The at least one processor 901 can generate information on a display component 903. Display component 903 can include one or more of a display driver, a display card, display or any other hardware and/or software required to display an image or series of images. Computing device 900 can also include a network interface 904 that allows the device to send and receive information signals via a network. Network interface 904 can include any type of network adapter for connecting to a network, such as an adapter to establish a connection to the Internet, to a wired or wireless intranet, to a cellular network or to a wireless network. Computing device 900 can also include a user interface 905. User interface 905 can include one or more components, such as display 802, one or more hard buttons 803, speaker 804, microphone 805 and optical devices 806, that can provide information to a user and/or receive inputs from a user. User interface 905 can also include one or more external components, such as an external keyboard, external mouse, external microphone, external speaker and the like.

Computing device 900 can include a power source 906. Power source 906 can provide power to any or all of the other components in computing device 900. As depicted in FIG. 9, power source 906 can be connected to, and provide power to, each of processor 901, memory 902, display 903, network interface 904 and user interface 905. Power source can be any type of power source, such as one or more disposable batteries, a rechargeable battery and the like. In the embodiment where computing device 900 is a portable device, such as a laptop computer, a tablet computer, a cell phone, a handheld computer and the like, the power source 906 may need to provide power for a period of time between recharging of the power source 906. When power source 906 is not connected to an external power source, computing device 900 is drawing on the power stored in power source 906. The capacity of power source 906 can vary with the type and size of power source 906. The rate at which power source 906 discharges depends on a number of factors, such as which components of computing device 900 are active, how much power each of the active components are drawing from power source 906 and the like.

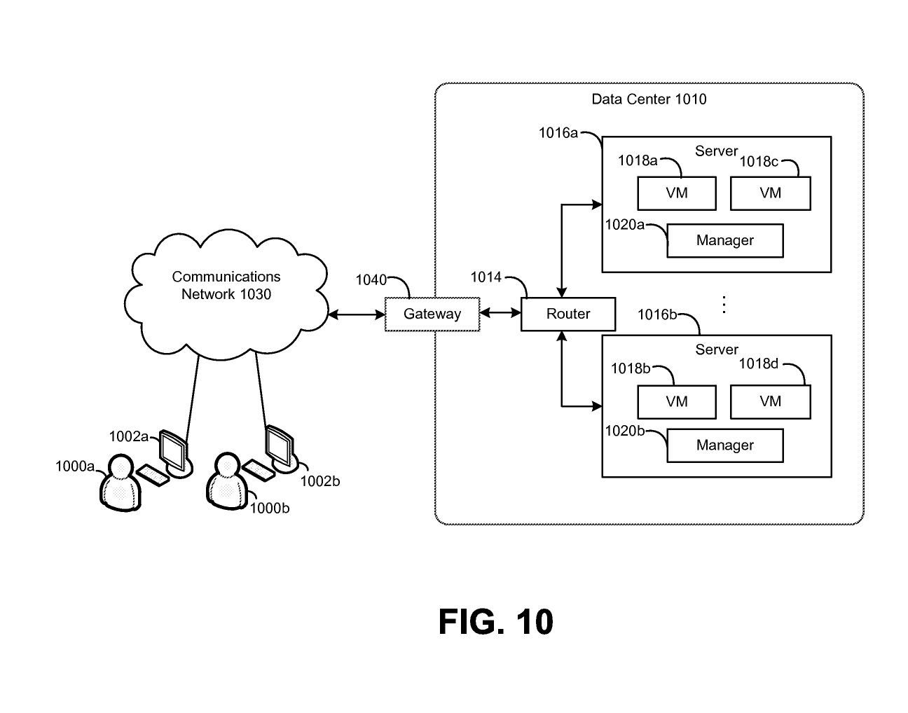

FIG. 10 illustrates an example computing environment in which the embodiments described herein may be implemented. FIG. 10 is a diagram schematically illustrating an example of a data center 1010 that can provide computing resources to users 1000a and 1000b (which may be referred herein singularly as user 1000 or in the plural as users 1000) via user computers 1002a and 1002b (which may be referred herein singularly as computer 1002 or in the plural as computers 1002) via a communications network 1030. Data center 1010 may be configured to provide computing resources for executing applications on a permanent or an as-needed basis. The computing resources provided by data center 1010 may include various types of resources, such as gateway resources, load balancing resources, routing resources, networking resources, computing resources, volatile and non-volatile memory resources, content delivery resources, data processing resources, data storage resources, data communication resources and the like. Each type of computing resource may be general-purpose or may be available in a number of specific configurations. For example, data processing resources may be available as virtual machine instances that may be configured to provide various web services. In addition, combinations of resources may be made available via a network and may be configured as one or more web services. The instances may be configured to execute applications, including web services, such as application services, media services, database services, processing services, gateway services, storage services, routing services, security services, encryption services, load balancing services, application services and the like. These web services may be configurable with set or custom applications and may be configurable in size, execution, cost, latency, type, duration, accessibility and in any other dimension. These web services may be configured as available infrastructure for one or more clients and can include one or more applications configured as a platform or as software for one or more clients. These web services may be made available via one or more communications protocols. These communications protocols may include, for example, hypertext transfer protocol (HTTP) or non-HTTP protocols. These communications protocols may also include, for example, more reliable transport layer protocols such as transmission control protocol (TCP) and less reliable transport layer protocols such as user datagram protocol (UDP). Data storage resources may include file storage devices, block storage devices and the like.

Each type or configuration of computing resource may be available in different sizes, such as large resources—consisting of many processors, large amounts of memory and/or large storage capacity—and small resources—consisting of fewer processors, smaller amounts of memory and/or smaller storage capacity. Users may choose to allocate a number of small processing resources as web servers and/or one large processing resource as a database server, for example.

Data center 1010 may include servers 1016a and 1016b (which may be referred herein singularly as server 1016 or in the plural as servers 1016) that provide computing resources. These resources may be available as bare metal resources or as virtual machine instances 1018a-d and (which may be referred herein singularly as virtual machine instance 1018 or in the plural as virtual machine instances 1018). The availability of virtualization technologies for computing hardware has provided benefits for providing large scale computing resources for customers and allowing computing resources to be efficiently and securely shared between multiple customers. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource. Furthermore, some virtualization technologies may provide virtual resources that span one or more physical resources, such as a single virtual machine instance with multiple virtual processors that spans multiple distinct physical computing systems.

Referring to FIG. 10, communications network 1030 may, for example, be a publicly accessible network of linked networks and possibly operated by various distinct parties, such as the Internet. In other embodiments, communications network 1030 may be a private network, such as, a corporate or university network that is wholly or partially inaccessible to non-privileged users. In still other embodiments, communications network 1030 may include one or more private networks with access to and/or from the Internet.

Communications network 1030 may provide access to computers 1002. User computers 1002 may be computers utilized by users 1000 or other customers of data center 1010. For instance, user computer 1002a or 1002b may be a server, a desktop or laptop personal computer, a tablet computer, a wireless telephone, a personal digital assistant (PDA), an e-book reader, a game console, a set-top box or any other computing device capable of accessing data center 1010. User computer 1002a or 1002b may connect directly to the Internet (e.g., via a cable modem or a Digital Subscriber Line (DSL)). Although only two user computers 1002a and 1002b are depicted, it should be appreciated that there may be multiple user computers.

User computers 1002 may also be utilized to configure aspects of the computing resources provided by data center 1010. In this regard, data center 1010 might provide a gateway or web interface through which aspects of its operation may be configured through the use of a web browser application program executing on user computer 1002. Alternately, a stand-alone application program executing on user computer 1002 might access an application programming interface (API) exposed by data center 1010 for performing the configuration operations. Other mechanisms for configuring the operation of various web services available at data center 1010 might also be utilized.

Servers 1016 shown in FIG. 10 may be standard servers configured appropriately for providing the computing resources described above and may provide computing resources for executing one or more web services and/or applications. In one embodiment, the computing resources may be virtual machine instances 1018. In the example of virtual machine instances, each of the servers 1016 may be configured to execute an instance manager 1020a or 1020b (which may be referred herein singularly as instance manager 1020 or in the plural as instance managers 1020) capable of executing the virtual machine instances 1018. The instance managers 1020 may be a virtual machine monitor (VMM) or another type of program configured to enable the execution of virtual machine instances 1018 on servers 1016, for example. As discussed above, each of the virtual machine instances 1018 may be configured to execute all or a portion of an application.

It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example data center 1010 shown in FIG. 10, a router 1014 may be utilized to interconnect the servers 1016a and 1016b. Router 1014 may also be connected to gateway 1040, which is connected to communications network 1030. Router 1014 may be connected to one or more load balancers, and alone or in combination may manage communications within networks in data center 1010, for example, by forwarding packets or other data communications as appropriate based on characteristics of such communications (e.g., header information including source and/or destination addresses, protocol identifiers, size, processing requirements, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 10 has been greatly simplified and that many more networks and networking devices may be utilized to interconnect the various computing systems disclosed herein. These network topologies and devices should be apparent to those skilled in the art.

It should also be appreciated that data center 1010 described in FIG. 10 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway or other computing device may comprise any combination of hardware or software that can interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders) and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

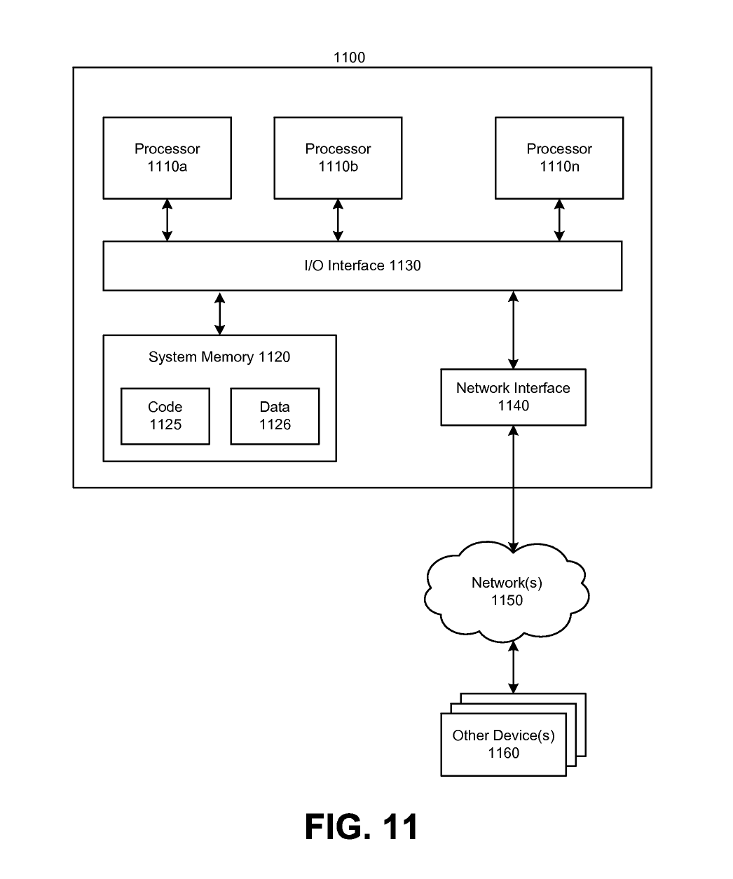

In at least some embodiments, a server that implements a portion or all of one or more of the technologies described herein may include a general-purpose computer system that includes or is configured to access one or more computer-accessible media. FIG. 11 depicts a general-purpose computer system that includes or is configured to access one or more computer-accessible media. In the illustrated embodiment, computing device 1100 includes one or more processors 1110a, 1110b and/or 1110n (which may be referred herein singularly as “a processor 1110” or in the plural as “the processors 1110”) coupled to a system memory 1120 via an input/output (I/O) interface 1130. Computing device 1100 further includes a network interface 1140 coupled to I/O interface 1130.

In various embodiments, computing device 1100 may be a uniprocessor system including one processor 1110 or a multiprocessor system including several processors 1110 (e.g., two, four, eight or another suitable number). Processors 1110 may be any suitable processors capable of executing instructions. For example, in various embodiments, processors 1110 may be general-purpose or embedded processors implementing any of a variety of instruction set architectures (ISAs), such as the x86, PowerPC, SPARC or MIPS ISAs or any other suitable ISA. In multiprocessor systems, each of processors 1110 may commonly, but not necessarily, implement the same ISA.

System memory 1120 may be configured to store instructions and data accessible by processor(s) 1110. In various embodiments, system memory 1120 may be implemented using any suitable memory technology, such as static random access memory (SRAM), synchronous dynamic RAM (SDRAM), nonvolatile/Flash®-type memory or any other type of memory. In the illustrated embodiment, program instructions and data implementing one or more desired functions, such as those methods, techniques and data described above, are shown stored within system memory 1120 as code 1125 and data 1126.

In one embodiment, I/O interface 1130 may be configured to coordinate I/O traffic between processor 1110, system memory 1120 and any peripherals in the device, including network interface 1140 or other peripheral interfaces. In some embodiments, I/O interface 1130 may perform any necessary protocol, timing or other data transformations to convert data signals from one component (e.g., system memory 1120) into a format suitable for use by another component (e.g., processor 1110). In some embodiments, I/O interface 1130 may include support for devices attached through various types of peripheral buses, such as a variant of the Peripheral Component Interconnect (PCI) bus standard or the Universal Serial Bus (USB) standard, for example. In some embodiments, the function of I/O interface 1130 may be split into two or more separate components, such as a north bridge and a south bridge, for example. Also, in some embodiments some or all of the functionality of I/O interface 1130, such as an interface to system memory 1120, may be incorporated directly into processor 1110.

Network interface 1140 may be configured to allow data to be exchanged between computing device 1100 and other device or devices 1160 attached to a network or networks 1150, such as other computer systems or devices, for example. In various embodiments, network interface 1140 may support communication via any suitable wired or wireless general data networks, such as types of Ethernet networks, for example. Additionally, network interface 1140 may support communication via telecommunications/telephony networks, such as analog voice networks or digital fiber communications networks, via storage area networks, such as Fibre Channel SANs (storage area networks) or via any other suitable type of network and/or protocol.

In some embodiments, system memory 1120 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1100 via I/O interface 1130. A non-transitory computer-accessible storage medium may also include any volatile or non-volatile media, such as RAM (e.g. SDRAM, DDR SDRAM, RDRAM, SRAM, etc.), ROM etc., that may be included in some embodiments of computing device 1100 as system memory 1120 or another type of memory. Further, a computer-accessible medium may include transmission media or signals, such as electrical, electromagnetic or digital signals, conveyed via a communication medium, such as a network and/or a wireless link, such as those that may be implemented via network interface 1140. Portions or all of multiple computing devices, such as those illustrated in FIG. 11, may be used to implement the described functionality in various embodiments; for example, software components running on a variety of different devices and servers may collaborate to provide the functionality. In some embodiments, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

A compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

A network set up by an entity, such as a company or a public sector organization to provide one or more web services (such as various types of cloud-based computing or storage), accessible via the Internet and/or other networks to a distributed set of clients may be termed a provider network. Such a provider network may include numerous data centers hosting various resource pools, such as collections of physical and/or virtualized computer servers, storage devices, networking equipment and the like, needed to implement and distribute the infrastructure and web services offered by the provider network. The resources may in some embodiments be offered to clients in various units related to the web service, such as an amount of storage for storage, processing capability for processing, as instances, as sets of related services and the like. A virtual computing instance may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

A number of different types of computing devices may be used singly or in combination to implement the resources of the provider network in different embodiments, including general-purpose or special-purpose computer servers, storage devices, network devices and the like. In some embodiments a client or user may be provided direct access to a resource instance, e.g., by giving a user an administrator login and password. In other embodiments the provider network operator may allow clients to specify execution requirements for specified client applications and schedule execution of the applications on behalf of the client on execution platforms (such as application server instances, Java™ virtual machines (JVMs), general-purpose or special-purpose operating systems, platforms that support various interpreted or compiled programming languages such as Ruby, Perl, Python, C, C++ and the like or high-performance computing platforms) suitable for the applications, without, for example, requiring the client to access an instance or an execution platform directly. A given execution platform may utilize one or more resource instances in some implementations; in other implementations multiple execution platforms may be mapped to a single resource instance.

In many environments, operators of provider networks that implement different types of virtualized computing, storage and/or other network-accessible functionality may allow customers to reserve or purchase access to resources in various resource acquisition modes. The computing resource provider may provide facilities for customers to select and launch the desired computing resources, deploy application components to the computing resources and maintain an application executing in the environment. In addition, the computing resource provider may provide further facilities for the customer to quickly and easily scale up or scale down the numbers and types of resources allocated to the application, either manually or through automatic scaling, as demand for or capacity requirements of the application change. The computing resources provided by the computing resource provider may be made available in discrete units, which may be referred to as instances. An instance may represent a physical server hardware platform, a virtual machine instance executing on a server or some combination of the two. Various types and configurations of instances may be made available, including different sizes of resources executing different operating systems (OS) and/or hypervisors, and with various installed software applications, runtimes and the like. Instances may further be available in specific availability zones, representing a logical region, a fault tolerant region, a data center or other geographic location of the underlying computing hardware, for example. Instances may be copied within an availability zone or across availability zones to improve the redundancy of the instance, and instances may be migrated within a particular availability zone or across availability zones. As one example, the latency for client communications with a particular server in an availability zone may be less than the latency for client communications with a different server. As such, an instance may be migrated from the higher latency server to the lower latency server to improve the overall client experience.

In some embodiments the provider network may be organized into a plurality of geographical regions, and each region may include one or more availability zones. An availability zone (which may also be referred to as an availability container) in turn may comprise one or more distinct locations or data centers, configured in such a way that the resources in a given availability zone may be isolated or insulated from failures in other availability zones. That is, a failure in one availability zone may not be expected to result in a failure in any other availability zone. Thus, the availability profile of a resource instance is intended to be independent of the availability profile of a resource instance in a different availability zone. Clients may be able to protect their applications from failures at a single location by launching multiple application instances in respective availability zones. At the same time, in some implementations inexpensive and low latency network connectivity may be provided between resource instances that reside within the same geographical region (and network transmissions between resources of the same availability zone may be even faster).

Thus, as set forth above, a content provider may provide content to a destination over a network, such as the Internet, using, for example, streaming content delivery techniques. A content provider may, for example, provide a content delivery service that may reside on one or more servers. The service may be scalable to meet the demands of one or more customers and may increase or decrease in capability based on the number and type of incoming client requests. The content delivery service may, in some cases, process a content item in parallel across multiple nodes of the content delivery service. This may be done, in one embodiment, to reduce the latency for rendering the content item. Portions of the content delivery service may also be migrated to be placed in a position of reduced latency with a requesting client. In some cases, the content provider may determine an “edge” of a system or network associated with the content provider that is physically and/or logically closest to a requesting client. The content provider may then, for example, “spin-up,” migrate resources or otherwise employ components associated with the determined edge for interacting with requests from the client. Such an edge determination process may, in some cases, provide an efficient technique for identifying and employing components that are well suited to interact with a particular client, and may, in some embodiments, reduce the latency for communications between a content provider and one or more clients.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A system comprising:
a computing device; and
a store application running on the computing device, the store application configured to permit a user to request that an application run on the computing device;
wherein the computing device is configured to:
initiate an application streaming session with a server system in response to the store application receiving a first request to run the application, wherein during the application streaming session the computing device is configured to receive application content generated by the server system, render the application content received from the server system, receive a user input associated with the rendered application content, and send input information based at least in part on the user input to the server system,
download, from the server system, an application file for the application during at least a portion of the application streaming session,
install the application on the computing device using the application file,
receive state information associated with the application streaming session from the server system, and
launch the installed application on the computing device using the state information in response to receiving a second request to run the application.

2. The system of claim 1, wherein the computing device is further configured to initiate the application streaming session in response to determining that the application is a free application.

3. The system of claim 1, wherein the computing device is further configured to use the state information to modify the application when the application is launched on the computing device.

4. The system of claim 1, wherein the server system is configured to send the state information to the computing device in response to the application streaming session being halted.

5. A method comprising:
receiving, by a computing device, a first input associated with an application;
establishing, by the computing device, an application streaming session associated with the application, wherein the computing device performs at least the following during the application streaming session:
rendering application content received from a server system, and
sending input information to the server system, the input information based at least in part on one or more user inputs;
downloading, by the computing device, an application file for the application during at least a portion of the application streaming session; and
installing the application on the computing device using the application file.

6. The method of claim 5, further comprising:
launching, by the computing device, the installed application in response to receiving a second input associated with the application.

7. The method of claim 6, wherein the launching occurs in response to completion of installing the application on the computing device.

8. The method of claim 6, wherein the second input associated with the application is a request to run the application.

9. The method of claim 5, further comprising:
receiving, by the computing device, the one or more user inputs while rendering the application content.

10. The method of claim 5, wherein the server system is configured to control a version of the application running in the server system based at least in part on the input information.

11. The method of claim 10, wherein the servers system comprises at least one host and wherein the version of the application running in the server system is running on the at least one host.

12. The method of claim 11, wherein the at least one host comprises at least one of an individual computing device or a virtualized instance.

13. The method of claim 5, further comprising:
receiving, by the computing device, state information generated by the server system during the application streaming session.

14. The method of claim 13, wherein launching the installed application in response to receiving a second request to run the application comprises using the state information to modify the application when the application is launched on the computing device.

15. The method of claim 5, further comprising:
receiving, by the computing device, a stream of the application content from the server system.

16. The method of claim 15, wherein the stream of the application content comprises a stream of video content, and wherein the computing device is configured to display the stream of video content on a display.

17. The method of claim 15, wherein the stream of the application content comprises a stream of audio content, and wherein the computing device is configured to render the stream of audio content on an audio device.

18. The method of claim 5, further comprising:
determining, by the computing device, whether an amount of memory for applications on the computing device is filled.

19. The method of claim 16, further comprising:
in response determining that an amount of memory for applications on the computing device is filled, deleting one or more applications on the computing device before downloading the application file.

20. A non-transitory computer-readable medium having embodied thereon computer-readable instructions, the computer-readable instructions comprising instructions that, when executed by a server system, at least cause:
receiving, by the server system from a computing device, a request for an application;
determining, by the server system, whether the application is a free application;
initiating, by the server system, an application streaming session with the computing device in response to determining that the application is a free application, wherein the server system is configured to perform the following during the application streaming session:
generating application content by a version of the application running on the server system,
sending the generated application content to the computing device,
receiving input information from the computing device, and
controlling the version of the application running on the server system based at least in part on one or more user inputs; and
sending, by the server system, an application file for the application during at least a portion of the application streaming session.

21. The non-transitory computer-readable medium of claim 20, wherein the server system comprises a host, and wherein the version of the application is running on the host.

22. The non-transitory computer-readable medium of claim 20, the computer-readable instructions further comprising instructions that, when executed by a server system, at least cause:
adding, by the server system, at least one additional host in response to determining that a number of applications streaming sessions in the server system is approaching a limit.

23. The non-transitory computer-readable medium of claim 20, the computer-readable instructions further comprising instructions that, when executed by a server system, at least cause:
sending, by the server system to the computing device, digital rights management information for the application to the computing device.

24. The non-transitory computer-readable medium of claim 20, the computer-readable instructions further comprising instructions that, when executed by a server system, at least cause:
determining, by the server system, whether state information was generated by the version of the application during the application streaming session.

25. The non-transitory computer-readable medium of claim 24, the computer-readable instructions further comprising instructions that, when executed by a server system, at least cause:
sending, by the server system to the computing device, the state information in response to determining that the state information was generated by the version of the application during the application streaming session.
